(19) United States
(12) Patent Application Publication
(10) Pub. No.: US 2002/0150002 A1
(43) Pub. Date: Oct. 17, 2002

(54) Optical pickup and method of assembling the optical pickup

(76) Inventors: Jung-Gug Pae, Gyeonggi-do (KR); Jong-uk Kim, Gyeonggi-do (KR)

Correspondence Address: STAAS & HALSEY LLP, 700 11TH STREET, NW, SUITE 500, WASHINGTON, DC, 20001, US

(21) Appl. No.: 10/022,836

(22) Filed: Dec. 20, 2001

(30) Foreign Application Priority Data
Apr. 12, 2001 (KR) 2001-19568

(51) Int. Cl. G11B 7/095; G11B 17/00; G11B 21/16; G11B 7/00; G02B 7/02

(52) U.S. Cl. 369/44.16; 369/244; 369/44.22; 359/824; 359/814

(57) ABSTRACT

An optical pickup compatible with an optical disc having a deflection error. The optical pickup includes a blade on which an objective lens is mounted, a focus coil and a tracking coil mounted around the blade, and a magnet and a yoke driving the blade by generating an electromagnetic force induced by the current flowing through the focus and tracking coils, wherein the magnet is displaced a predetermined distance from the center line of the blade such that the electromagnetic force acting on the blade in a focus direction is asymmetrical. The structure of the optical pickup causes an intentional radial rolling of the blade to make the optical axis of the objective lens approximately perpendicular to the recording surface of the disc. Therefore, the optical pickup is effective for a focus control on a disc having a deflection error.

### CROSS-REFERENCE TO RELATED APPLICATIONS

This application claims the benefit of Korean Patent Application No. 2001-19568 filed on Apr. 12, 2001, in the Korean Industrial Property Office, the disclosure of which is incorporated herein by reference.

### BACKGROUND OF THE INVENTION

1. Field of the Invention

The present invention relates to an optical pickup used to record information on and reproduce information from a disc, and more particularly, to an optical pickup compatible with a disc having a deflection error and a method of assembling the optical pickup.

2. Description of the Related Art

In general, optical recording and/or reproducing apparatuses, such as a compact disc player (CDP) or digital versatile disc player (DVDP), include an optical pickup to record information on and reproduce information from a disc or other optical storage medium, by radiating a light beam on a recording surface of the disc and receiving a light beam reflected from the same while moving across a radial direction of the disc or other optical storage medium.

Referring to FIGS. 1 through 3, a conventional optical pickup includes a holder 8 fixed on a base 7, a blade 2 movably supported by an elastic support 6 having one end fixed to the holder 8, an objective lens 1 mounted on the blade 2, a focusing coil 3 and a tracking coil 4 mounted on the blade 2 to drive the objective lens 1 in a focus direction A and track direction B, and a magnet 10 and a yoke 9 to generate an electromagnetic force induced by the current flowing through the focusing and tracking coils 3 and 4 to drive the blade 2. Reference numeral 11 denotes a turntable on which a disc D is seated, and reference numeral 12 denotes a motor that turns the turntable 11.

In the optical pickup having the structure described above, as current flows through the focusing coil 3, the blade 2, supported by the elastic support 6, is driven in the focus direction A by the electromagnetic force generated by current and a magnetic force from the magnet 10 and the yoke 9. Thus, a focal distance between the recording surface of the disc D and the objective lens 1 can be controlled by adjusting the amount of current flowing through the focusing coil 3. In a similar way, the blade 2 can be driven appropriately in the tracking direction by electromagnetic force by controlling the amount of current flowing along the tracking coil 4, thereby enabling the objective lens 1 to accurately follow a target track on the disc D.

However, since the blade 2 is movably fixed to one end of the elastic support 6, as described above, rolling occurs as well as vertical and horizontal displacements of the blade 2 to perform focusing and tracking operations. The rolling of the blade 2 to the left or right is classified into a tangential rolling about an axis parallel to the radial direction of the disc, as shown in FIG. 2, and a radial rolling about an axis perpendicular to the radial direction of the disc D, as shown in FIG. 3.

Ideally, the recording surface of the disc D is formed to be level. Practically, however, the disc D is deflected upward or downward slightly with a so-called deflection error. This deflection error of the disc D acts as a kind of focusing error when the disc D is operated with the optical pickup. In particular, when the disc D having a deflection error is rotated on the turntable 11, the focal distance between the objective lens 1 of the optical pickup and the disc D is varied by an amount corresponding to the deflection error. Therefore, the optical pickup performs a focus control to compensate for such error.

Radial rolling of the optical pickup during a focusing operation may act in different ways, i.e., it can offset or amplify such a deflection error. In the case where a deflection error of a disc is offset by radial rolling of the optical pickup, the radial rolling of the blade 2 occurs in a (+) direction (see FIG. 3) as the objective lens 1 approaches the disc D by upward displacement of the blade 2, and in a (−) direction as the objective lens 1 becomes more distant from the disc D by downward displacement of the blade 2 (first case). In this case, as shown in FIG. 4, such radial rolling of the blade 2 makes the optical axis C1 of the objective lens 10 substantially perpendicular to the recording surface of the disc D having a deflection error as a focusing control of the objective lens 1 is carried out in response to the deflection error of the disc D. As a result, the deflection error of the disc D can effectively be offset by the radial rolling of the blade 2.

On the contrary, in the case where a deflection error of a disc is amplified by radial rolling of the optical pickup, the radial rolling of the blade 2 occurs in a (−) direction (see FIG. 3) as the objective lens 1 approaches the disc D, and in a (+) direction as the objective lens 1 becomes more distant from the disc D (second case). This opposite rolling to the case described with reference to FIG. 4 makes the objective lens 1 deviate from a position where the optical axis C1 of the objective lens 1 is perpendicular to the recording surface of the disc D, as shown in FIG. 5.

Another way in which radial rolling of the optical pickup acts is such that when the objective lens 1 moves toward and away from the disc 1, radial rolling of the optical pickup occurs in the same direction, (+) or (−) direction (third case). In this case, such radial rolling of the optical pickup is advantageous in offsetting a deflection error of the optical disc only in either upward or downward movement of the optical pickup for focus control. Movement of the optical pickup in the other direction for focus control is destructive.

For improved focus control performance, among the three cases described above, the first case is most desirable, but it is best to avoid the second and third cases if possible. Rolling characteristics of the optical pickup in use are affected by many factors, such as an assembly margin in the manufacture of the optical pickup. A special effort to control the direction of rolling of the optical pickup has not been made so that the three cases of optical pickup rolling described above appear at approximately equal ratios in optical pickups being produced.

Therefore, there is a need to induce an optical pickup to have radial rolling characteristics of the first case for improved performance of control.

### SUMMARY OF THE INVENTION

Accordingly, it is an object of the present invention to provide an optical pickup and a method of assembling the optical pickup in which radial rolling of the optical pickup occurs in a desired direction to provide focus control operation.

Additional objects and advantages of the invention will be set forth in part in the description which follows and, in part, will be obvious from the description, or may be learned by practice of the invention.

The foregoing and other objects of the present invention are achieved by providing an optical pickup comprising: a blade on which an objective lens is mounted and which is movably supported with respect to a predetermined holder by an elastic support; a focus coil and a tracking coil mounted on the blade; a magnet generating an electromagnetic force driving the blade in focusing and tracking directions of a disc, the electromagnetic force generated by current flowing through the focus and tracking coils; and a yoke supporting the magnet and generating a magnetic path, wherein the magnet is displaced a predetermined distance from the center line of the blade such that the electromagnetic force, acting on the blade in the focus direction and generated by current flowing through the focus coil, is asymmetrical.

The above and other objects of the present invention may also be achieved by providing an optical pickup comprising: a blade on which an objective lens is mounted; a plurality of elastic supports movably supporting the blade with respect to a predetermined holder; a focus coil and a tracking coil mounted on the blade; a magnet generating an electromagnetic force driving the blade in focusing and tracking directions of a disc, the electromagnetic force generated by current flowing through the focus and tracking coils; and a yoke supporting the magnet and generating a magnetic path, wherein the plurality of elastic supports have different levels of stiffness and are arranged around the center line of the blade such that the blade moves asymmetrically in the focus direction.

The above and other objects of the present invention are further achieved by providing a method of assembling an optical pickup, the method comprising: preparing an optical pickup assembly which includes a blade on which an objective lens is mounted and which is movably supported with respect to a predetermined holder by an elastic support, a focus coil and a tracking coil mounted on the blade, a magnet generating an electromagnetic force induced by current flowing through the focus and tracking coils to drive the blade in focusing and tracking directions of a disc, and a yoke supporting the magnet and generating a magnetic path; and adjusting the position of the magnet supported by the yoke by applying a force using a predetermined jig.

### BRIEF DESCRIPTION OF THE DRAWINGS

These and other objects and advantages of the present invention will become apparent and more readily appreciated from the following description of the embodiments, taken in conjunction with the accompany drawings of which:

FIG. 1 is a plan view of a conventional optical pickup;

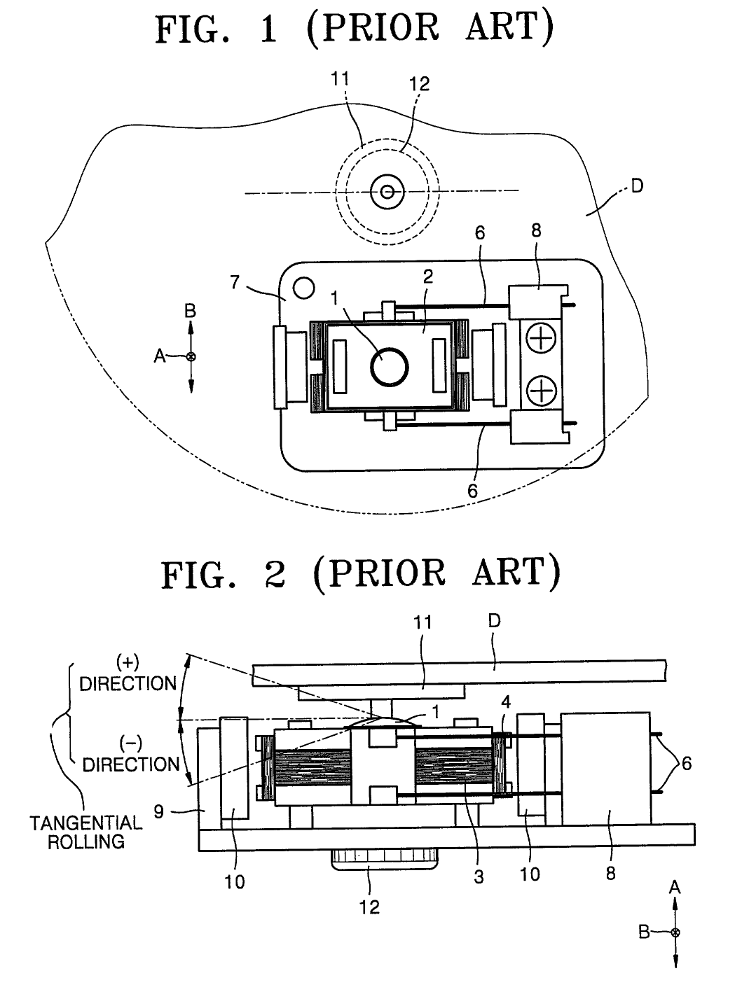

FIG. 2 is a front view of the conventional optical pickup of FIG. 1;

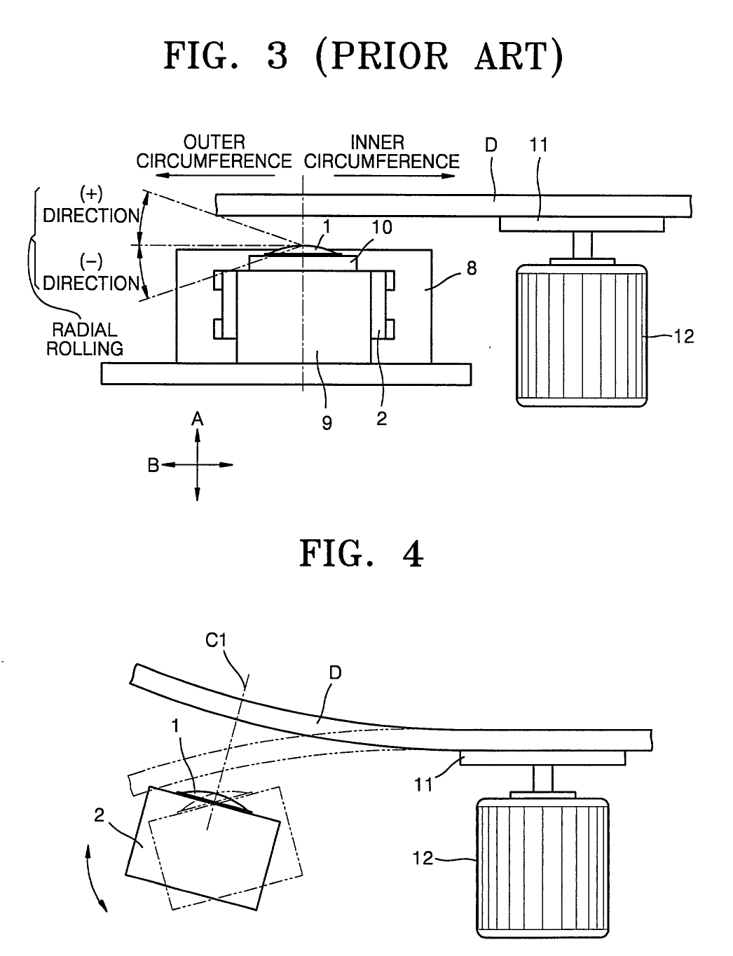

FIG. 3 is a side view of the conventional optical pickup of FIG. 1;

FIGS. 4 and 5 illustrate the influences of radial rolling of an optical pickup on controlling focus;

FIG. 6 shows an embodiment of an optical pickup according to the present invention;

FIGS. 7A and 7B show a process of assembling the optical pickup of FIG. 6; and

FIG. 8 shows another embodiment of the optical pickup according to the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

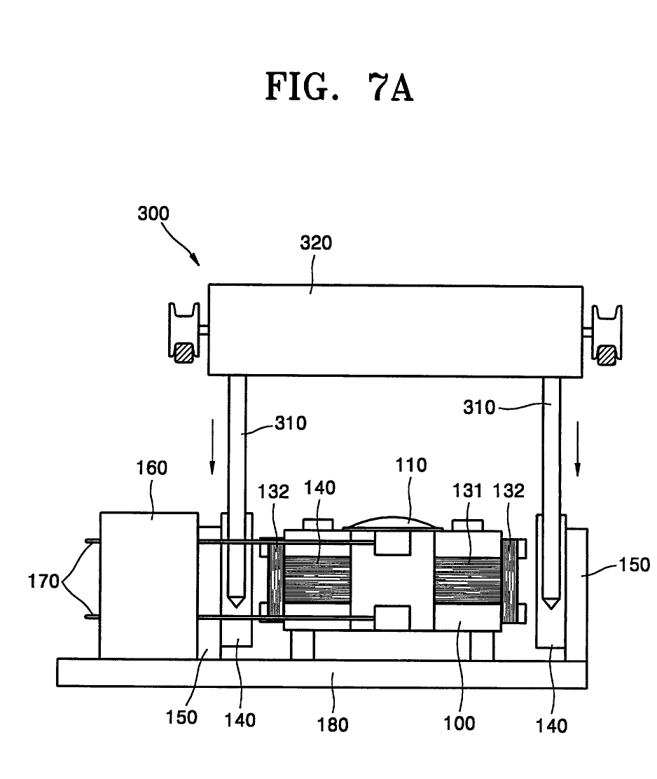

Referring to FIG. 6, in an optical pickup according to an embodiment of the present invention, a holder 160 and a yoke 150 on which a magnet 140 is mounted are fixed on a base 180. A blade 100 on which an objective lens 110 is mounted is movably supported with respect to the holder 160 by a plurality of elastic supports 170. A focus coil 131 and a tracking coil 132, serving as a unit driving the blade 100 in focus direction A and tracking direction B, respectively, by inducing an electromagnetic force through interaction with the magnet 140 and the yoke 150, are wound around and placed at opposite ends of the blade 100, respectively.

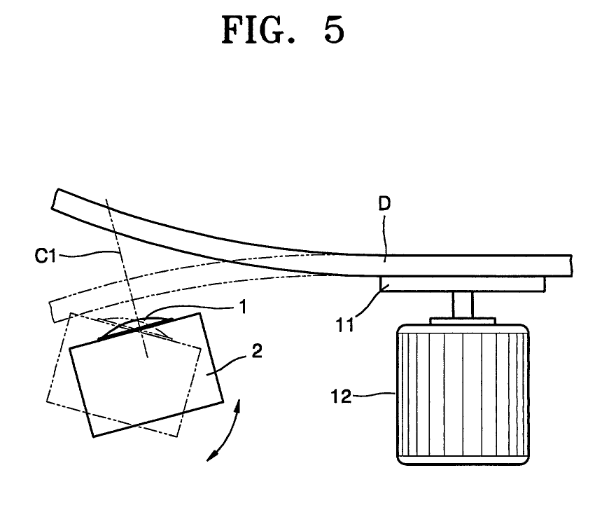

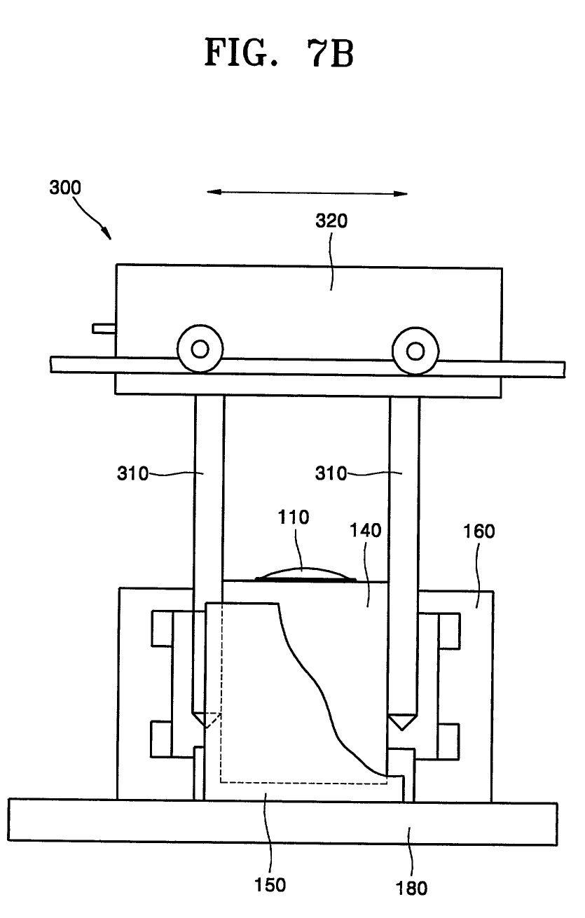

A magnet 140 is displaced a predetermined distance S from a center line C2 to induce an electromagnetic force acting asymmetrically on the focus coil 131. This arrangement of the magnet 140 can be achieved using a jig 300, as shown in FIGS. 7A and 7B. The jig 300 includes an elevating arm 310 holding the sides of the magnet 140 and a movable stand 320 supporting and moving the elevating arm 310. Once an optical pickup assembly is prepared, the elevating arm 310 of the jig 300 is moved down to hold the magnet 140 mounted on the yoke 150, and the movable stand 320 is migrated toward the outer or inner circumference of the disc D to shift the position of the magnet 140. In this embodiment of the invention, the magnet 140 is moved a predetermined distance S towards the outer circumference of the disc D to cause radial rolling of the optical pickup in a (+) direction (see FIG. 3).

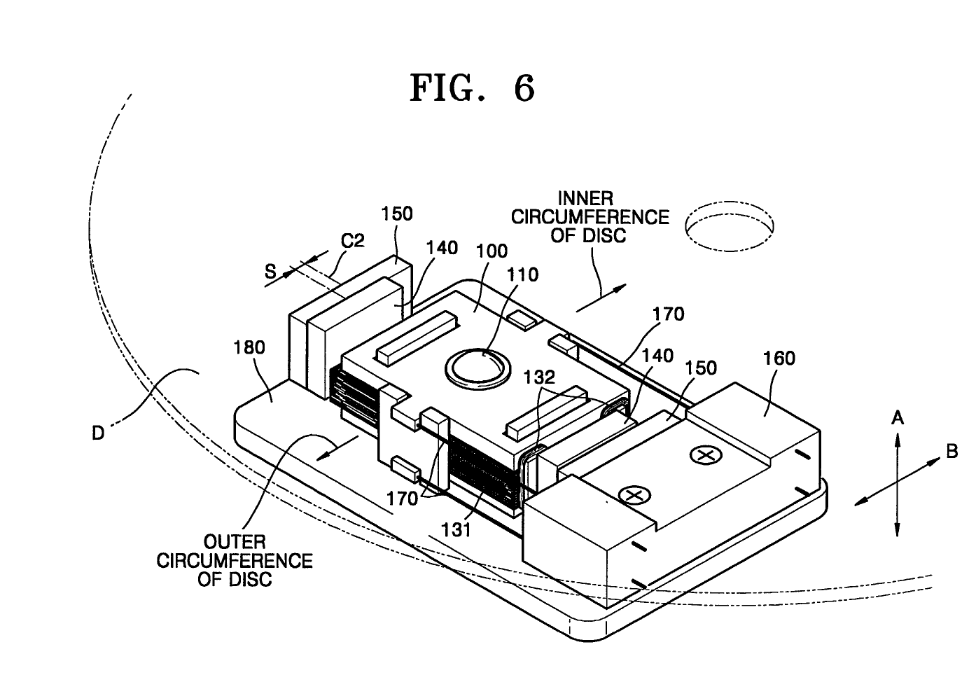

As a result, the electromagnetic force acting on the blade 100 during a focusing operation is greater toward the center of the disc D than the outer circumference of the disc D, thereby causing the blade 100 to tilt in the (+) direction. Therefore, rolling of the blade 100 occurs in such a way that a deflection error of the disc D can be offset in a focus control operation, as in the case described with reference to FIG. 4, thereby enabling intended focus control.

Thus, when the magnet 140 is intentionally shifted to an asymmetric position, the electromagnetic force acting on the blade 100 becomes asymmetric, causing the blade 100 to tilt in the (+) direction. Therefore, focus control on a deflected disc can effectively be achieved.

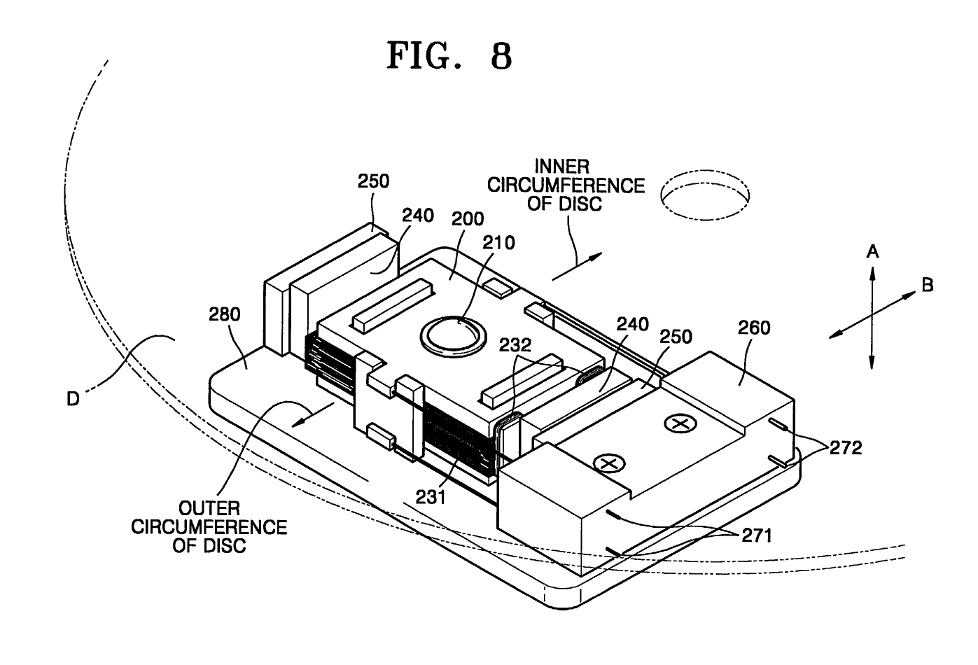

FIG. 8 shows another embodiment of the optical pickup according to the present invention. Referring to FIG. 8, the optical pickup includes a base 280, a holder 260, a yoke 250, a magnet 240, and a blade 200 on which an objective lens is mounted and supported by a plurality of elastic supports 271 and 272. The structure of the optical pickup of FIG. 8 is designed to cause the blade 200 to tilt in the (+) direction by using the elastic supports 271 and 272, which have different amounts of stiffness, not by asymmetrically arranging the magnet 240. In particular, the elastic support 271, positioned close to the outer circumference of the disc D, has a stiffness less than the elastic support 272 positioned close to the center the disc D so that displacement of the blade 200 is greater towards the outer circumference of the disc D for a focus control operation.

Therefore, radial rolling of the optical pickup in the (+) direction is caused as in the previous embodiment, thereby performing an effective focus control on a deflected disc by changing the amount of current flowing through the focusing coil.

As described above, the optical pickup according to the present invention can be intentionally tilted in a desired direction during a focus control operation by an electromagnetic force acting asymmetrically on the blade so that the optical pickup can be effectively applied for focus controlling to a disc having a deflection error.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An optical pickup for use with a disc, comprising:
a blade on which an objective lens is mounted and which is movably supported with respect to a holder by an elastic support;
a focus coil and a tracking coil mounted on the blade;
a magnet generating an electromagnetic force driving the blade in focusing and tracking directions of with respect to the disc, the electromagnetic force generated by current flowing through at least one of the focus and tracking coils;
wherein the magnet is displaced a predetermined distance from a center line of the blade such that the electromagnetic force acts on the blade asymmetrically.

2. The optical pickup of claim 1, wherein the magnet is displaced in a radial direction of the disc toward the outer circumference of the disc.

3. An optical pickup for use with a disc, comprising:
a blade on which an objective lens is mounted;
a plurality of elastic lens supports movably supporting the blade with respect to a holder;
a focus coil and a tracking coil mounted on the blade;
a magnet generating an electromagnetic force driving the blade in focusing and tracking directions of the disc, the electromagnetic force generated by current flowing through the focus and tracking coils;
wherein at least one of said the plurality of elastic supports has a level of stiffness different from at least one other one of said plurality of elastic supports such that the blade tilts around an axis of the blade as the blade moves in the focusing direction.

4. The optical pickup of claim 3, wherein the plurality of elastic supports are arranged such that at least one of the plurality of elastic supports close to the outer circumference of the disc is relatively less stiff than another one of said plurality of elastic supports close to a center of the disc.

5. A method of assembling an optical pickup, the method comprising:
preparing an optical pickup assembly which includes a blade on which an objective lens is mounted and which is movably supported with respect to a predetermined holder by an elastic support, a focus coil and a tracking coil mounted on the blade, a magnet generating an electromagnetic force induced by current flowing through at least one of the focus and tracking coils to drive the blade in at least one of focusing and tracking directions of a disc, and
adjusting a position of the magnet by applying a force to the magnet.

6. The method of claim 5, wherein, in adjusting the position of the magnet, the magnet is moved in a radial direction of the disc toward the outer circumference of the disc.

7. The method according to claim 6, wherein the force is applied to the magnet using a jig configured to hold two opposite ends of the magnet.

8. A method of assembling an optical pickup, the method comprising:
preparing an optical pickup assembly which includes a blade on which an objective lens is mounted and which is movably supported with respect to a predetermined holder by an elastic support, a focus coil and a tracking coil mounted on the blade, a magnet generating an electromagnetic force induced by current flowing through at least one of the focus and tracking coils to drive the blade in at least one of focusing and tracking directions of a disc; and
providing a plurality of elastic supports each having level of stiffness different from the other said plurality of elastic supports such that the blade tilts around an axis of the blade as the blade moves in the focusing direction.

9. An optical pickup comprising:
a blade on which an objective lens is mounted and which is movably supported with respect to a holder;
a focus coil and a tracking coil mounted on the blade;
a magnet generating an electromagnetic force driving the blade in at least one of focusing and tracking directions of a disc, the electromagnetic force generated by current flowing through at least one of the focus and tracking coils;
a support unit supporting the blade to tilt around an axis of the blade as the blade moves in the focusing direction.

10. An optical pickup comprising:
a blade on which an objective lens is mounted and which is movably supported with respect to a predetermined holder;
a focus coil and a tracking coil mounted on the blade;
a magnet generating an electromagnetic force driving the blade in at least one of focusing and tracking directions of a disc, the electromagnetic force generated by current flowing through at least one of the focus and tracking coils;
a unit forcibly moving the blade to tilts around an axis of the blade as the blade moves in the focusing direction.

11. A method of moving a blade of an optical pickup in a focus direction with respect to the disc, the method comprising:
applying a predetermined amount of force at one end of said blade; and
applying a greater amount of force than the predetermined amount at an opposite end of said blade, to asymmetrically move the blade to compensate for a deflection error of the disc.

12. An optical pickup comprising:
a blade on which an objective lens is mounted and which is movably supported with respect to a holder;
a focus coil and a tracking coil mounted on the blade;
a magnet generating an electromagnetic force driving the blade in at least one of focusing and tracking directions of a disc, the electromagnetic force generated by current flowing through at least one of the focus and tracking coils;
wherein said blade is configured to tilts around an axis thereof.

13. An optical reproducing and recording apparatus comprising:
a turntable on which a disc is seated;
a motor to rotate the turntable; and
an optical pickup to reproduce information from and recording information on the disc;
the optical pickup comprising:
a blade on which an objective lens is mounted and which is movably supported with respect to a holder by an elastic support;
a focus coil and a tracking coil mounted on the blade;
a magnet generating an electromagnetic force driving the blade in focusing and tracking directions with respect to the disc, the electromagnetic force generated by current flowing through at least one of the focus and tracking coils;
wherein the magnet is displaced a predetermined distance from a center line of the blade such that the electromagnetic force acts on the blade asymmetrically.

14. The optical reproducing and recording apparatus of claim 13, wherein the magnet is displaced in a radial direction of the disc toward the outer circumference of the disc.

15. An optical reproducing and recording apparatus comprising:
a turntable on which a disc is seated;
a motor to rotate the turntable; and
an optical pickup to reproduce information from the recording information of the disc, the optical pickup comprising:
a blade on which an object lens is mounted;
a plurality of elastic lens supports movably supporting the blade with respect to a holder;
a focus coil and a tracking coil mounted on the blade;
a magnet generating an electromagnetic force driving the blade in focusing and tracking directions of the disc, the electromagnetic force generated by current flowing through the focus and tracking coils;
wherein at least one of the plurality of elastic supports has a level of stiffness different from at least one other one of the plurality of elastic supports such that the blade tilts around an axis of the blade as the blade moves in the focusing direction.

16. The optical reproducing and recording apparatus of claim 15, wherein the plurality of elastic supports are arranged such that at least one of the plurality of elastic supports close to the outer circumference of the disc is relatively less stiff than another one of said plurality of elastic supports close to the center of the disc.
